(19) United States
(12) Patent Application Publication
(10) Pub. No.: US 2022/0238007 A1
(43) Pub. Date: Jul. 28, 2022

(54) SYSTEM AND METHOD FOR AUTOMATED SECURITY EVENT TRACKING AND LOGGING BASED ON CLOSED LOOP RADIO COMMUNICATIONS

(71) Applicant: Patriot One Technologies Inc., Toronto (CA)

(72) Inventors: Jonathan Taylor MILLAR, Fredericton (CA); James Allan Douglas CAMERON, Fredericton (CA); Matthew Aaron Rogers CARLE, Fredericton (CA)

(21) Appl. No.: 17/649,116

(22) Filed: Jan. 27, 2022

Related U.S. Application Data
(60) Provisional application No. 63/141,998, filed on Jan. 27, 2021.

(51) Int. Cl. G08B 27/00; G06V 40/16; G06V 20/40; G08B 21/02

(52) U.S. Cl. CPC G08B 27/005; G06V 40/166; G06V 40/172; G06V 20/41; G08B 21/02; G06V 20/44

(57) ABSTRACT

A system and method of a threat detection system to automatically disseminate information being communicated over a communications channel during an event to help coordinate resources from the command center. By using speech processing algorithms along with artificial intelligence and natural language processing (NLP), a threat detection system can pull out key insights from the radio communication between the security personnel. Text in the radio frequencies can be recorded and transcribed and actionable alerts can be created.

### CROSS REFERENCE TO RELATED APPLICATIONS

The application claims priority to and the benefit of U.S. Provisional Patent Application Ser. No. 63/141,998, entitled “SYSTEM AND METHOD FOR AUTOMATED SECURITY EVENT TRACKING AND LOGGING BASED ON CLOSED LOOP RADIO COMMUNICATIONS”, filed on Jan. 27, 2021, the disclosure of which is incorporated herein by reference in its entirety.

### BACKGROUND

The embodiments described herein relate to security and surveillance, in particular, technologies related to video recognition threat detection.

Threat detection systems may include video management systems (VMS) which consist of components responsible for collecting video from cameras and other sources, recording or storing that video to a storage device and providing an interface to both view the live video, and access the recorded video.

Security screening and/or threat detection systems are installed in offices, airports and buildings to screen for potential threats (i.e., knives, guns, weapons, etc.). Radio communication is used by security professionals to relay real time information between different points within the threat detection system.

Certain threat detect systems may not provide logs of active events. Since the communication within the threat detection system is continuous and real-time, the system can log active events and constantly scan the radios wavelengths for relevant events and prepare data to be consumed by the end users.

There is a desire to implement active logging and analytics features in a threat detection system.

### SUMMARY

A system and method of a threat detection system to automatically disseminate information being communicated over one or more communications channels during a monitoring period to help coordinate resources from the command center. By using speech processing algorithms along with artificial intelligence and natural language processing (NLP), a threat detection system can pull out key insights from the radio communication between the security personnel. Text in the radio frequencies can be recorded and transcribed and actionable alerts can be created.

### BRIEF DESCRIPTION OF THE DRAWINGS

FIG. 1 is a diagram describing the requirements of a multi-sensor threat detection platform.

FIG. 2 is a diagram illustrating the Security Assist module.

FIG. 3 is a block diagram illustrating an embodiment of the threat detection system.

### DETAILED DESCRIPTION

In a preferred embodiment, a multi-channel covert threat detection system is disclosed. This covert threat detection system utilizes software, artificial intelligence (AI) to detect and defend against active threats that are detected or created in the audio domain (e.g., detection of noises, audio warnings, specific speech patterns and words) to inform security personnel of the presence and approximate location of these threats.

The threat detection system may allow the system operator to easily determine if the system is operational without requiring testing with actual triggering events. This can be accomplished through the use of special non-emergency keywords. For example, the word ‘nana is sleeping’ could be coded to a particular alert status, and uttered by security personnel to indicate they are testing that the system is operating properly. When the system responds with the acknowledgment that the ‘special status’ of ‘nana is sleeping’ has been detected on one of the common audio channels, this status can then be indicated to the security team to confirm correct operation.

For radio systems equipped with identification of either the particular radio that originated the signal, or for radio systems equipped with location information (GPS or triangulation), the information about the location and source of the alert can be added to the alert signal regarding the alert status. In an additional embodiment, for those systems not equipped with identification or location information, the operator may also encode their name, station number, or location in the audio signal that would then be interpreted and relayed by the system.

There are a wide number of situations that could be encoded regarding the audio signal, from special sounds like a gunshot or explosion, to specific status warning events that are vocalized by the security operator. Examples include “shot fired”, “person in distress”, “medical attention needed”, Code 145”, “rowdy behaviour”, “suspicious person detected” and the like.

In addition, fixed, mobile, or temporarily fixed microphones can also be added easily to the system to catch vocalizations or other problematic sounds made by the crowd or members of the public. Similarly for these sensors, audio can be transmitted to the platform for correlating the continuous stream of audio with the signatures of problematic events.

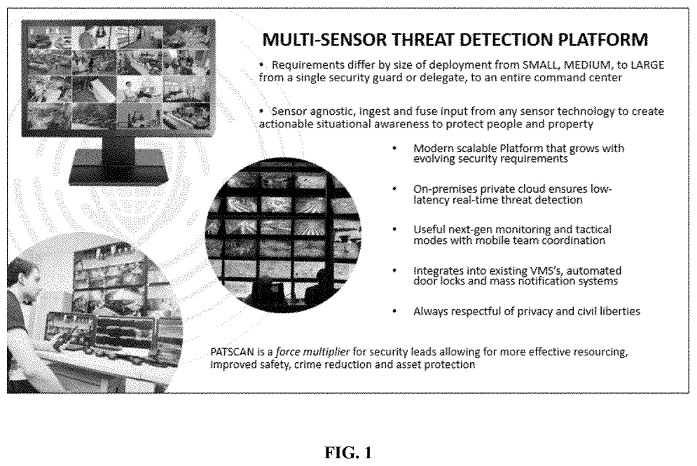

FIG. 1 is a diagram describing the requirements of a multi-sensor threat detection platform. As seen in FIG. 1, a multi-sensor threat detection platform or system should have the following requirements, including:
Requirements for different size deployments from small, medium to large from a single security guard or delegate, to an entire command center.
Sensor agnostic, ingest and fuse input from any sensor technology to create actionable situational awareness to protect people and property.
Modern scalable Platform that grows with evolving security requirements.
On-premises private cloud ensures low-latency real-time threat detection.
Useful next-gen monitoring and tactical modes with mobile team coordination.
Integrates into existing video management system (VMS), automated door locks and mass notification systems.
Always respectful of privacy and civil liberties.

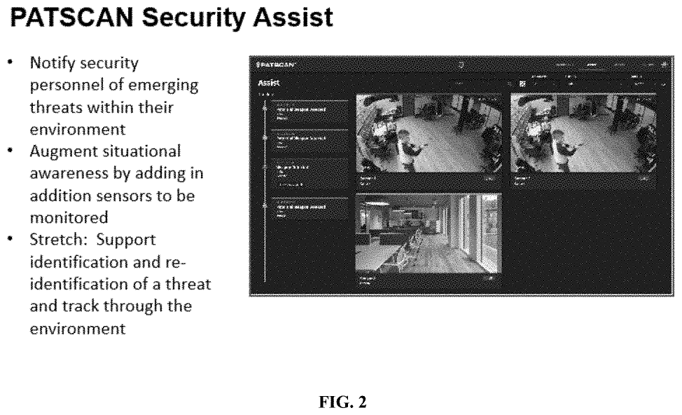

FIG. 2 is a diagram illustrating the Security Assist module. As seen in FIG. 2, the system also has Security Assist module that:
Notify security personnel of emerging threats within their environment.
Augment situational awareness by adding in additional sensors to be monitored.
Support identification and re-identification of a threat and track through the environment.

There is a desire for having the ability to automatically disseminate information being communicated over radio frequencies during an active event to help coordinate resources from the command center. By using speech processing algorithms along with artificial intelligence or natural language processing (NLP), a threat detection system can pull out key insights from the radio communication between the security personnel.

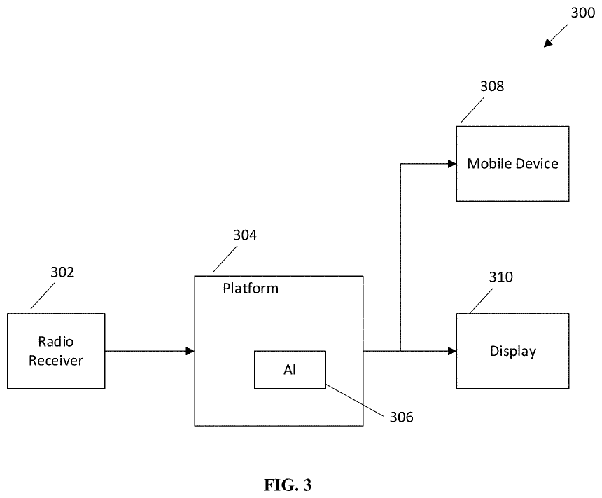

FIG. 3 is a block diagram illustrating an embodiment of a threat detection system. According to FIG. 3, threat detection system 300 includes a radio receiver 302 that receives signals from one or more mobile devices on one or more radio or audio channels. The radio receiver transfers the input data to a threat detection platform 304. The threat detection platform 304 comprises one or more computer processors and an artificial intelligence module 306 capable of supporting natural language processing (NLP and/or speech recognition). One advantage of this system is that multiple languages can be simultaneously interpreted, to detect a wider range of threat sounds. The threat detection platform 304 transcribes the input data and outputs the results to a computer monitor display and/or the mobile device of the security personnel.

The output of the threat detection platform can be text to be sent to a visual computer display 310 or to a mobile device 308. In further embodiments, the output can also be an audio signal broadcast to one or more of the audio communications channels monitored by security personnel. This audio notification may be either delayed or attenuated if there is active communication between security personnel on that channel. This audio signal broadcast can be accomplished through standard text-to-speech mechanisms, and can also be translated into multiple languages.

For example, a call out of “Shots fired in the atrium” is immediately logged, and the threat detection system brings up cameras in the operations center from the atrium along with options to activate 3^{rd} party applications such as mass notification or door locks. Hot action words such as “shots fired”, “suspect”, “gun”, “knife”, “threat detected”, “I'm gonna knock your block off” may create actionable actions.

According to embodiments of the disclosure, the detection enables security professionals to react quicker to information that comes over the radio. Operation centers get quicker access to site wide information in order to make instant decisions. This technology also logs information that can be used after the fact for forensic investigations; all information is recorded including CCTV, optical cameras and thermal camera feeds.

According to further embodiments of the disclosure, the detection supports real-time, automatic transcription into the ear/ear-piece of the security personnel. In a further embodiment, the transcription is to support a silent mode or more discrete alerts whereby it is a more discrete way of alerting people who need to know.

In a further embodiment, the transcription and recording can occur in the background or after the fact to ensure real-time nature of the surveillance. In a further embodiment, the transcription can also elevate to different security codes. For example, if something happens, then elevate security code to “code red”.

In a further embodiment, the security messages can be broadcast to an entire facility, for example by a Public Address (PA) system. The facility broadcast may be a different message than those delivered to security personnel, to maintain calm in the crowd, but also to ensure they are informed of a situation in a timely manner.

According to embodiments of this disclosure, a threat detection system for automatically disseminating information over a communications channel during an active event. The threat detection system consists of a computer processor, a communications channel to receive signals from one or more mobile devices, a threat detection platform, and an artificial intelligence (AI) module on the threat detection platform to process information. Upon receiving radio frequencies at the radio receiver, the information is sent to the threat detection platform to process the information and create actionable alerts.

According to the disclosure, the AI module of the threat detection platform supports natural language processing (NLP) and speech recognition, and the AI module of the threat detection platform supports specific noise detection.

According to the disclosure, the text in the communications channel can be recorded and transcribed. The threat detection platform transcribes the input data and outputs the results to a computer monitor display or the mobile device of the security personnel. The transcribed data is communicated over an audio channel to security personnel. The transcribed data is translated to another language before being converted to audio and communicated to security personnel.

According to the disclosure, the threat detection platform recognizes hot action words or key phrases. The hot action word is selected from a list consisting of “Shots fired”, “suspect”, “gun”, “knife”, “threat detected” and “bomb”. Furthermore, the actionable alerts include at least one of bringing up cameras feed, triggering mass notification or broadcasting of messages, and triggering door locks (e.g., lockdown conditions).

According to further embodiments of this disclosure, a computer implemented method of automatically disseminating information over a communications channel during an event using a threat detection system is disclosed. The computer implemented method consists of the steps of receiving information from a communications channel connected to one or more mobile devices, sending the received information to a threat detection platform, processing and classifying the received information to identify potential threats using an artificial intelligence (AI) module, identifying potential threats by recognizing hot action word or key phrases, creating actionable alerts, and sending the actionable alerts to security sources.

According to further disclosure of the method, the communication channel is comprised of a set of radio frequencies. The AI module supports natural language processing (NLP) and speech recognition. The text in a communications channel can be recorded and transcribed.

According to further disclosure of the method, the threat detection system can pull out key insights from the radio communication between the security personnel. The threat detection platform transcribes the input data and outputs the results to a computer monitor display or the mobile device of the security personnel. The threat detection platform recognizes hot action words or key phrases. The hot action words are selected from a list consisting of “shots fired”, “suspect”, “gun”, “knife”, “threat detected” and “bomb”.

According to further disclosure of the method, the actionable alerts include at least one of bringing up cameras feed, triggering mass notification, broadcasting of messages, and triggering door locks. The security sources include security personnel, other mobile devices, and display on a command center.

Implementations disclosed herein provide systems, methods and apparatus for generating or augmenting training data sets for machine learning training. The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer. It should be noted that a computer-readable medium may be tangible and non-transitory. As used herein, the term “code” may refer to software, instructions, code or data that is/are executable by a computing device or processor. A “module” can be considered as a processor executing computer-readable code.

A processor as described herein can be a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, or microcontroller, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, any of the signal processing algorithms described herein may be implemented in analog circuitry. In some embodiments, a processor can be a graphics processing unit (GPU). The parallel processing capabilities of GPUs can reduce the amount of time for training and using neural networks (and other machine learning models) compared to central processing units (CPUs). In some embodiments, a processor can be an ASIC including dedicated machine learning circuitry custom-build for one or both of model training and model inference.

The disclosed or illustrated tasks can be distributed across multiple processors or computing devices of a computer system, including computing devices that are geographically distributed. The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.” While the foregoing written description of the system enables one of ordinary skill to make and use what is considered presently to be the best mode thereof, those of ordinary skill will understand and appreciate the existence of variations, combinations, and equivalents of the specific embodiment, method, and examples herein. The system should therefore not be limited by the above described embodiment, method, and examples, but by all embodiments and methods within the scope and spirit of the system. Thus, the present disclosure is not intended to be limited to the implementations shown herein but is to be accorded the widest scope consistent with the principles and novel features disclosed herein.

What is claimed is:

1. A threat detection system for automatically disseminating information over a communications channel during an active event, comprising:
a computer processor;
a communications channel to receive signals from one or more mobile devices;
a threat detection platform; and
an artificial intelligence (AI) module on the threat detection platform to process information;
wherein upon receiving radio frequencies at the radio receiver, the information is sent to the threat detection platform to process the information and create actionable alerts.

2. The system of claim 1 whereby the AI module of the threat detection platform supports natural language processing (NLP) and speech recognition.

3. The system of claim 2 whereby the AI module of the threat detection platform supports specific noise detection.

4. The system of claim 1 whereby text in the communications channel can be recorded and transcribed.

5. The system of claim 1 whereby the threat detection platform transcribes the input data and outputs the results to a computer monitor display or the mobile device of the security personnel.

6. The system of claim 5 whereby the transcribed data is communicated over an audio channel to security personnel.

7. The system of claim 5 whereby the transcribed data is translated to another language before being converted to audio and communicated to security personnel.

8. The system of claim 1 whereby the threat detection platform recognizes hot action words or key phrases.

9. The system of claim 8 wherein the hot action word is selected from a list consisting of “shots fired”, “suspect”, “gun”, “knife”, “threat detected” and “bomb”.

10. The system of claim 1 whereby the actionable alerts include at least one of bringing up cameras feed, triggering mass notification, broadcasting of messages, and triggering door locks.

11. A computer implemented method of automatically disseminating information over a communications channel during an event using a threat detection system, comprising:
receiving information from a communications channel connected to one or more mobile devices;
sending the received information to a threat detection platform;
processing and classifying the received information to identify potential threats using an artificial intelligence (AI) module;
identifying potential threats by recognizing hot action words or key phrases;
creating actionable alerts; and
sending the actionable alerts to security sources.

12. The method of claim 11 whereby the communication channel is comprised of a set of radio frequencies.

13. The method of claim 11 whereby the AI module supports natural language processing (NLP) and speech recognition.

14. The method of claim 11 whereby the text in a communications channel can be record and transcribed.

15. The method of claim 11 whereby the threat detection system can pull out key insights from the radio communication between the security personnel.

16. The method of claim 11 whereby the threat detection platform transcribes the input data and outputs the results to a computer monitor display or the mobile device of the security personnel.

17. The method of claim 11 whereby the threat detection platform recognizes hot action words or key phrases.

18. The system of claim 17 wherein the hot action word is selected from a list consisting of “Shots fired”, “suspect”, “gun”, “knife”, “threat detected” and “bomb”.

19. The system of claim 11 whereby the actionable alerts include at least one of bringing up cameras feed, triggering mass notification, broadcasting of messages, and triggering door locks.

20. The method of claim 11 whereby the security sources include security personnel, other mobile devices and display on a command center.
